(19) United States
(12) Patent Application Publication
(10) Pub. No.: US 2007/0247048 A1
(43) Pub. Date: Oct. 25, 2007

(54) Gated nanorod field emitters

(75) Inventors: Anping Zhang, Niskayuna, NY (US); Joleyn Eileen Balch, Clifton Park, NY (US); Loucas Tsakalakos, Niskayuna, NY (US); Heather Diane Hudspeth, Clifton Park, NY (US); Reed Roeder Corderman, Niskayuna, NY (US)

Correspondence Address: Paul J. DiConza;General Electric Global Research, One Research Circle, Docket Room K1-4A59, Niskayuna, NY, 12309, US

(73) Assignee: General Electric Company, Schenectady, NY (US)

(21) Appl. No.: 11/234,023

(22) Filed: Sep. 23, 2005

(51) Int. Cl. H01J 1/00; H01J 9/00

(52) U.S. Cl. 313/311; 313/309; 313/310; 445/50; 445/24

(57) ABSTRACT

In a method of making a field emitter, at least one post (120) is formed on a semiconductor substrate (110). The post (120) extends upwardly from the substrate (110). The post (120) is monocrystalline with the substrate (110). A dielectric layer (130) is deposited on the substrate (110). The dielectric layer (130) defines a via (132) therethrough about the post (120). A conductive gate layer (140) is applied to the dielectric layer (130) so that the conductive gate layer (140) defines an opening that is juxtaposed with the via (132). At least one nanostructure (150) is grown upwardly from the top surface of the post (120).

### STATEMENT OF GOVERNMENT INTEREST

This invention was made with support from the U.S. government under grant number 70NANB2H3030, awarded by NIST. The government may have certain rights in the invention.

### BACKGROUND

1. Field of the Invention

The invention relates to nano-scale structures and, more specifically, to a nanostructured field emitter.

2. Description of the Prior Art

Conventional cold cathode field emitters include a plurality of substantially conical or pyramid-shaped emitter tips arranged in a grid surrounded by a plurality of grid openings, or gates. Conventional cold cathode field emitters may be fabricated using a number of methods.

Cold cathode field emission occurs when the local electric field at the surface of a conductor tip approaches about 10⁹ V/m and is work function and tip size related. The adsorbates on the tip may also alter the field emission performance of the tip. In this field regime, the work function barrier is reduced enough to permit electronic tunneling from the conductor to vacuum, even at room temperature. To achieve the high local fields at experimentally achievable macroscopic fields, field emission sources are typically made from sharp objects such as etched tip micro-fabricated cones or nano-structured conductors such as inorganic nanorods and carbon nanotubes (CNTs). For the majority of field emission applications, the cathode current needs to be controllable. In general, control is achieved with a gate located nearby the field emission source that generates the field required to eject electrons from the field emission source or turns off the cathode emitting current.

Cold cathode field emission devices have the capability to produce very high current density electron beams (greater than 100 A/cm²) with low power consumption. However field emission devices have not, to date, been incorporated into commercial high current density applications such as x-ray tubes for high performance computerized tomography (CT) scanner, high resolution displays, or high power amplifiers for power microwave electronics because field emission sources may fail prematurely unless extreme care is taken to protect the devices.

Typical field emission devices are variants of the conventional Spindt field emission array. This device design has several inherent vulnerabilities stemming from the small dimensions required to achieve a high enough field strength to emit electrons from a conical structure. Under ideal operating conditions (e.g. 10⁻⁹ Torr, with no perturbation in the gate voltage, gate currents or anode voltage), Spindt emitter arrays have been shown to emit in excess of 40 A/cm² for extended periods of time. In most applications however, the electron source typically encounters occasional plasma discharges, called spits. Spits are often caused by gas desorption from an anode surface that is ionized by the electron beam. The resulting plasma generates an arc between the anode and nearby surfaces at a lower potential such as the field emitter. Depending upon the cable capacitance, potential difference and embedded circuit protection, a spit has the potential to destroy field emitter devices, even if the spit does not land on the device itself. In high voltage applications, such as x-ray tubes, because spits typically draw more than 100 amps for less than 1 microsecond, the inductively and capacitively coupled currents will often destroy Spindt field emitter devices, even if the spit does not directly impact the field emission source. In addition, during the spit, the voltage on the anode often drops to a low enough value that the anode is no longer able to absorb the cathode current. Therefore, the gate electrode absorbs up to the entire cathode current. At moderate current densities in Spindt emitters, (greater than about 100 mA/cm²), ocalized heating from the excessive gate current can destroy the device quickly.

The Spindt method, however, does not address the problem of emitter tip degradation. Residual gas particles in the vacuum surrounding the plurality of substantially conical or pyramid-shaped emitter tips collide with emitted electrons and are ionized. The resulting ions bombard the emitter tips and damage their sharp points, decreasing the emission current of the cold cathode field emitter over time and limiting its operating life. Other problems associated with the Spindt method include: (1) number and complexity of the process fabrication steps; (2) tip size is intrinsically limited by the fabrication process so high gate bias is required for high field emission current and therefore high power consumption; and (3) blunting of the Spindt emitter caused by ion bombardment so higher and higher electric fields are required to obtain the same emission current

Recently, nanostructured materials, such as inorganic nanorods and carbon nanotubes, have been proposed as field emission sources. Because of their smaller tip diameter, excellent mechanical strength, high electrical conductivity and high thermal conductivity they offer some advantages over conventional Spindt-type field emitters: (1) inorganic nanorods and carbon nanotubes intrinsically have very small tip size and offer very high field enhancement factor, so the threshold electric field for emission is significantly reduced and field emission sources can operate at lower gate voltages compared to conical emitters; (2) work function of inorganic nanorods can be tuned by adjusting the doping concentration in semiconducting nanorods or selecting different materials; (3) inorganic nanorods and carbon nanotubes can be vertically aligned and have uniform diameter across the length, so degradation caused by blunting of the tips caused by ion bombardment is minimized. To date however, nanostructured field emission sources have not achieved current densities demonstrated in Spindt field emission source.

In a typical micro-fabricated cold-cathode gated field emission array comprising nanorods or carbon nanotubes, the gate leakage current is significantly high relative to the anode current due to some nanotips being placed horizontally too close to the gate electrode. Thus, what is still needed is a simple and efficient method to reduce the gate current of the cold cathode field emitter array that includes sharp and well-aligned tips of nanorods or carbon nanotubes. The positioning of nanotips relative to the gate electrode horizontally should be well controlled to increase the emitting current and reduce the gate leakage current.

Existing micro-fabricated field emitters including nanorods or nanotubes do not address the problem of vertical distance of emitter tip to gate electrode. If the nanorods or nanotubes are short within the gate opening, the emitter tip to gate distance is significantly affected by the thickness of the dielectric layer disposed between the two. A smaller emitter tip to gate distance may be achieved by depositing a thinner dielectric layer. However, this results in the undesired consequences of: limiting the gate voltage due to the breakdown of the thin dielectric film, increasing the capacitance between the cathode electrode and the gate electrode, and increasing the response time of the cold cathode field emitter. If the nanorods or nanotubes are long, they may be too close to the gate electrode and therefore increase the gate current. Likewise, existing field emitters do not address the problem of emission uniformity. Due to the difficulty in positioning nanorods or nanotubes in the same position within all gate openings, some of the field emitters in a given sample will be inoperative.

Another type of existing field emitter includes a substrate separated from a gate metal layer by a dielectric layer. A passage is formed through the gate metal layer and the dielectric layer to expose a portion of the substrate. A metal post is then disposed on the substrate in the via and a plurality of nanostructures, such as nanorods or nanotubes, is grown from the post. The nanorods or nanotubes act as exit points for electrons that are liberated when a potential is applied between the substrate and the gate metal layer. This type of field emitter allows for control of the distance between the nanostructures and the gate by controlling the height of the post. Also, by controlling the diameter of the post, the number of nanostructures is controlled. However, this structure has several disadvantages, including the existence of an interface between the post and the substrate that can introduce undesirable resistance. Also, the metal used in this structure is subject to melting or reacting with the underlying substrate at high temperatures that are typical in various fabrication processes; therefore, fabrication of this structure must be performed at a relatively low temperature.

Therefore, there is a need for a field emission source capable of producing uniform high current density that is more robust than conventional Spindt field emission devices.

There is also a need for a robust field emission device in which the gate current, threshold voltage and switching speed are comparable to or better than conventional Spindt field emitter arrays.

### SUMMARY OF THE INVENTION

The disadvantages of the prior art are overcome by the present invention, which, in one aspect, includes a method of making a field emitter, in which one post is formed on a substrate, with the post extending upwardly from the substrate. The substrate includes a semiconductor and the post is monocrystalline with the substrate. A dielectric layer is deposited on the substrate. The dielectric layer defines a via therethrough about the post. A conductive gate layer is applied to the dielectric layer so that the conductive gate layer defines an opening that is juxtaposed with the via. At least one nanostructure is grown upwardly from the top surface of the post.

In another aspect, the invention includes a field emitter with a semiconductor substrate. A post extends upwardly from the top surface. The substrate and the post are monocrystalline. A dielectric layer is disposed on the semiconductor substrate. The dielectric layer defines a via therethrough that exposes the post. A conductive gate layer is disposed on the outer surface. The gate layer defines an opening that exposes the via through the dielectric layer. At least one nanostructure extends upwardly from the post.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIGS. 1A-1B are schematic diagrams of illustrative embodiments of the invention.

FIGS. 1C-1E are micrographs showing different top perspective views of devices corresponding to the embodiment shown in FIGS. 1A-1B.

FIGS. 2A-2H are schematic diagrams showing a first embodiment of a method for making field emitters.

FIGS. 3A-3H are schematic diagrams showing a second embodiment of a method for making field emitters.

FIGS. 4A-4J are schematic diagrams showing a third embodiment of a method for making field emitters.

FIG. 5 is a micrograph of a domed precursor to a field emitter.

FIG. 6 is a front elevational view of an x-ray system.

FIG. 7 is a schematic diagram of portion of the x-ray generation subsystem.

### DETAILED DESCRIPTION OF THE INVENTION

A preferred embodiment of the invention is now described in detail. Referring to the drawings),like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and“on.” Unless otherwise specified herein, the drawings are not necessarily drawn to scale.

The methods disclosed below offer several advantages in the making of field emitters. For example, a semiconducting post structure that is monocrystalline with the substrate does not tend to melt or react with the substrate (as would a metal post structure) at normal fabrication temperatures of the nanostructures. The number and separation of the nanostructures may be controlled by placement of the nanostructure growth catalyst and through a catalyst wet etch step. Furthermore, the vertical separation of the gate and nanostructures may be controlled by controlling the post height and the height of the nanostructures. Also, horizontal separation of gates and nanostructures may be controlled by controlling the dielectric thickness and the diameter of the via. Because there is no interface between the post and the substrate, current loss between the post and, the substrate is significantly reduced, no interface resistance is introduced by the post. The post resistance may be tuned by the post diameter and height and the post serves as a resistor in series with the nanostructure. This can be used to reduce emission current when the emitting current is too high from one field emitter, thereby achieving more uniform emitting current in a micro-fabricated field emission array. The semiconductor post can be reduced so that multiple tips on the post are identical relative to the gate electrode in terms of field emission characteristics. Thus, when one tip of an array is damaged, another tip can replace it, resulting in the same field emission characteristics.

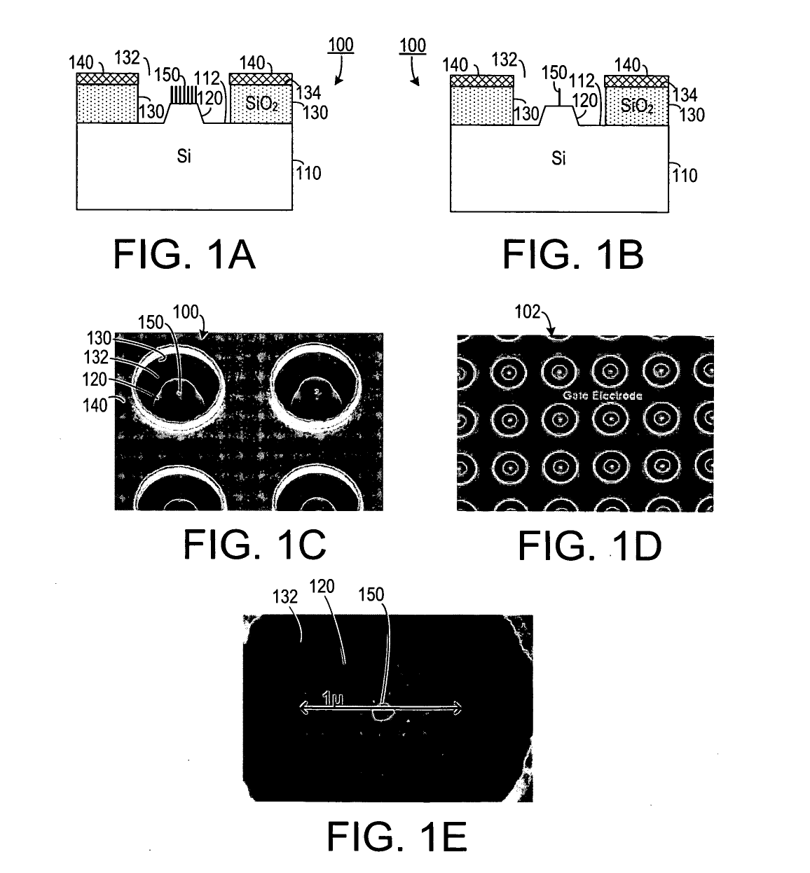

As shown in FIGS. 1A-1E, one illustrative embodiment of a field emitter 100 includes a semiconductor substrate 110 that has a top surface 112. The substrate 110 is made of a semiconducting substance, such as monocrystalline silicon, silicon carbide, gallium nitride, or other III-V semiconductors. The semiconducting substance of the substrate 110 may have an increased resistance through doping. A post 120 extends upwardly from the top surface 112 of the substrate 110. The substrate 110 and the post 120 form a single crystal and are, thus, monocrystalline.

A dielectric layer 130, made from an insulating material such as silicon dioxide, silicon nitride, or aluminum oxide, is disposed on the substrate 110 and defines a via 132 that exposes the post 120. The dielectric layer 130 may be made, for example, using plasma enhanced chemical vapor deposition),low-pressure chemical vapor deposition, or thermal evaporation. A gate layer 140, made of a conductive material such as a metal or polycrystalline silicon, is disposed on the outer surface 134. The gate layer also defines an opening that exposes the via 132 through the dielectric layer 130. At least one nanostructure 150, such as a carbon nanotube or an inorganic nano-rod (such as a metal carbide or silicon carbide nanorod), extends upwardly from the post 120. An inorganic nanorod could be made, for example, from such materials as: molybdenum carbide, silicon carbide, zinc oxide and silicon. The nanostructure 150 may be grown from the substrate using, for example, a catalyst and a catalytic vapor-liquid-solid (VLS) process, or chemical vapor deposition (CVD) process, or evaporation process. Examples of a suitable catalyst include, but are not limited to, gold, nickel, cobalt, iron, molybdenum, germanium, or their combination. The choice of catalyst depends on the composition of the nanorod to be grown.

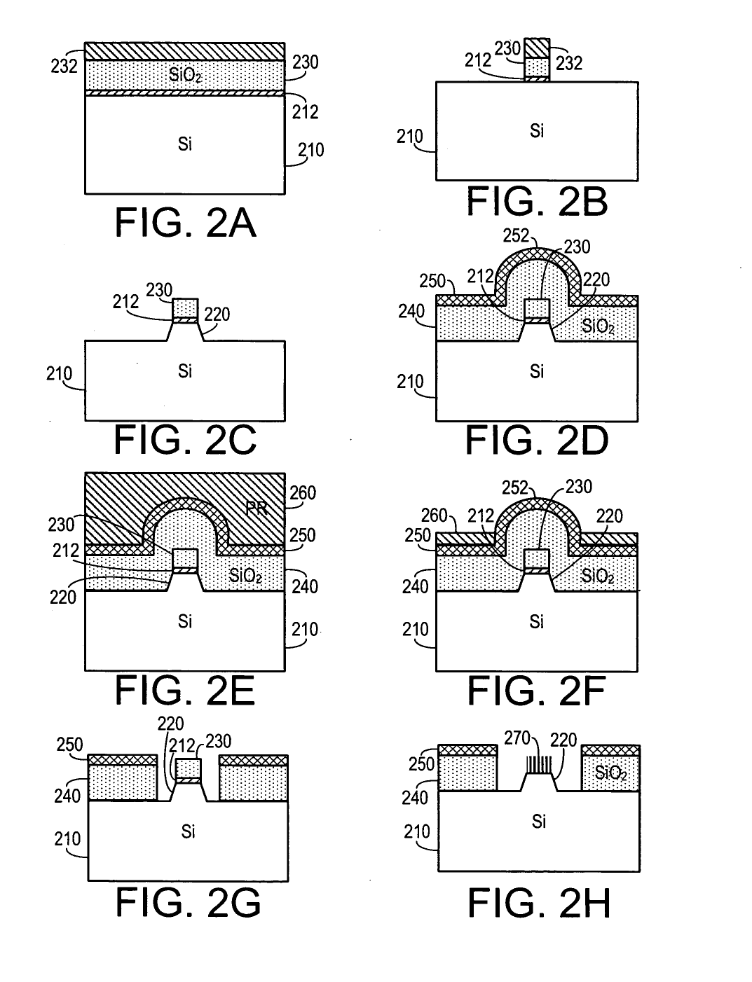

As shown in FIGS. 2A-2H, in one method of making a field emitter, a catalyst film 212 (such as a gold film) is applied to a semiconducting substrate 210 and a dielectric layer 230 is applied on top of the catalyst film 212. An optional thin titanium or chromium layer can be inserted between the catalyst film 212 and dielectric film 230 to promote adhesion. As shown in FIG. 2B, a photoresist mask 232 is disposed on the dielectric layer 230. The dielectric layer and the catalyst film are then etched, by a dry etch method such as reactive ion etch, high-density plasma etch, or purely ion milling, or wet etch, to expose the substrate except in the area under the mask. An optional wet etch can also be used to undercut the dielectric materials (such as oxide) to reduce the size of the mask. The dielectric layer 230 then acts as a mask in a subsequent etching process, such as reactive ion etch or high density plasma etch, in which a semiconducting post 220 is formed by etching the substrate 210, as shown in FIG. 2C.

As shown in FIG. 2D, a second dielectric layer 240 is applied to the substrate and a layer of a conductive gate material 250 is applied to the second dielectric layer 240. The dielectric layer 240 can be prepared by plasma enhanced chemical vapor deposition),low-pressure chemical vapor deposition or thermal evaporation. The conductive gate material can be deposited by e-beam evaporation, sputtering, or thermal evaporation. The second dielectric layer 240 and the conductive gate material layer 250 form a dome-shaped structure 252 above the post 220. In an alternate embodiment, a thin dielectric film (not shown) may be applied to the conductive gate material to inhibit growth of nanostructures in the nanostructure growth step (discussed below). Such a dielectric film may protect the gate during growth and improve selectivity during nanostructure growth. In such an embodiment, the thin dielectric film could be removed after the growth of the nanostructures. However, if left in place it can protect the gate from damage by ion bombardment during device operation

A photoresist layer 260, as shown in FIG. 2E, is applied so as to cover the dome-shaped structure 252. The photoresist layer 260 is baked to reflow to achieve a fat surface. Part of the photoresist layer 260 is removed by an oxygen plasma etch to expose a portion of the dome-shaped structure 252. The exposed portion of the dome-shaped structure 252 is etched by either dry etch or wet etch or the two combined to expose the post 220 and part of the substrate 210, as shown in FIG. 2G. Any remaining photoresist is removed and the nanostructure 270 is grown from the top of the post 220, using known methods such as the catalytic VLS, a CVD process, or evaporation process, as shown in FIG. 2H. The dome removal step can also be done by mechanical polishing, or chemical mechanical polishing (CMP). In some cases an etchant gas is used during growth to inhibit contamination of the sidewall or a post-growth treatment is used to eliminate the contaminations of the sidewall.

In one experimental example using the method of making a field emitter disclosed above, a gold (Au) catalyst layer having a thickness of about 100 Å or less, a thin titanium (Ti) layer having a thickness of about 50 Å or less were e-beam evaporated onto a silicon substrate. A layer of SiO₂ having a thickness of about 0.7 μm or less was deposited on the Si surface using plasma enhanced chemical vapor deposition (PECVD). The 50 Å Ti layer was used an adhesion promoter for the subsequent SiO₂ mask and was be removed at the same time as the SiO₂ mask. The wafers were then patterned with 1 μm (or 2 μm) dot arrays and a layer of photoresist was developed. The dot arrays were then wet etched to remove the SiO₂, Ti, and Au layers until the Si surface was exposed. Inductively coupled plasma (ICP) dry etch was then performed in Cl₂/Ar chemistries to form the Si posts array. It should be noted that the gas chemistries can be modified to achieve different angled sidewalls as needed. After forming the posts, about 1.2 μm PECVD SiO₂ and about 2000 Å TiW gate metal was subsequently deposited. An AZ1512 photoresist layer was then applied by spin coating and reflowed at 130° C. to achieve a flat resist surface, followed by an O₂ plasma dry etching of the photoresist to expose the top of the bumps. A wet etch was then used to remove the thin SiO₂ and a combined wet etch and dry etch was used to remove the TiW gate metal above the Si posts. It should be noted that the amount of gate metal undercut can be controlled to increase further the gate via openings if needed. The SiO₂ dielectric film inside the gate openings was dry etched to remove majority of the SiO₂ film. The residual SiO₂ and Ti were removed by a wet chemical etch. Nanorods were then grown on the post structure using a conventional vapor liquid solid/chemical vapor deposition (VLS/CVD) or evaporation process.

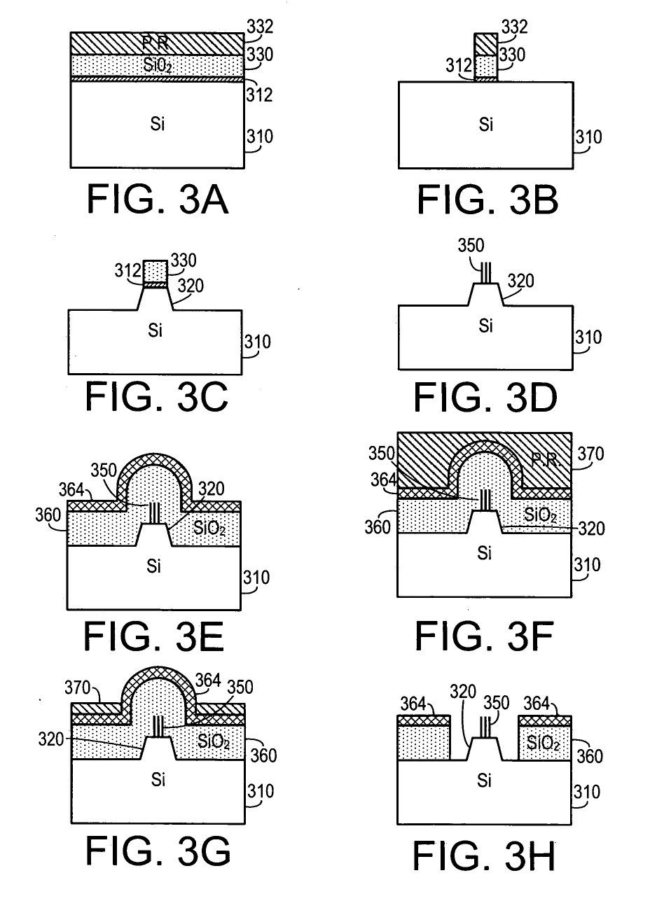

In another method for making a field emitter, as shown in FIGS. 3A-3H, a catalyst layer 312 is applied to a substrate 310 and a dielectric layer 330 is applied to the catalyst layer 312. A mask 332 is applied to the dielectric layer 330. As shown in FIG. 3B, the dielectric layer 330 is etched to expose the substrate 310. As shown in FIG. 3C, the exposed substrate is etched to form a post structure 320. A plurality of nanostructures 350 are grown from the substrate 310 using a process such as a VLS process, a CVD process, or an evaporation process. As shown in FIG. 3E, the substrate 310, the post 320 and the nanostructures 350 are covered by a second dielectric layer 360, which is covered by a conductive gate layer 364.

As shown in FIG. 3F, a layer of a mask material 370, such as photoresist, is applied to the conductive gate layer 364 and is reflowed by heating to achieve a flat resist surface, followed by an O₂ plasma dry etching of the photoresist until the dome structure 372 formed by the second dielectric layer 360 is exposed, as shown in FIG. 3G. The exposed gate material is removed, thereby exposing a portion of the second dielectric layer 360. The dome removal step can also be done by mechanical polishing, or chemical mechanical polishing (CMP). The exposed portion of the second dielectric layer 360 is then etched, as shown in FIG. 3H, to expose the substrate 310, the post 320 and the nanostructures 350. One advantage of this method is that, since the nanostructures are grown before the via in the process, there is no contamination in the via as a result of the nanostructure growth process and the growth process is well controlled to achieve aligned nanostructures.

In one experimental example using this method, a gold (Au) catalyst layer having a thickness of about 100 Å and a thin titanium (Ti) layer having a thickness of about 50 Å were e-beam evaporated onto a Silicon (Si) substrate. An SiO₂ having a thickness of about 0.5 μm was deposited on the Si surface using PECVD. The wafers were then patterned with an array of catalyst dots having a thickness of about 1 μm (or 2 μm, in one embodiment) and a photoresist layer was developed. The dot array was then wet etched to remove the SiO₂, Ti, and Au layers until the Si surface was exposed. Inductively coupled plasma (ICP) dry etch was then performed in a Cl₂/Ar chemistry to form the Si posts array. The oxide mask and Ti were then removed by a wet etch and then nanorod growth was accomplished using a conventional VLS/CVD process. After forming uniform nanorods on Si posts, a layer of about 1.2 μm SiO₂ was deposited using PECVD and a layer of about 1500 Å TiW gate metal was subsequently deposited. An Az1512 photoresist layer was then applied by spin coating and reflowed at 130° C. to achieve a flat resist surface, followed by an O₂ plasma dry etching of the photoresist to expose the top of the bumps. A wet etch was then used to remove the thin SiO₂ and TiW gate metal above the Si posts. The SiO₂ dielectric film inside the gate openings was dry etched to remove majority of the SiO₂ film. The residual SiO₂ and Ti were removed by a buffer oxide etch (BOE) wet etch. This method provides an advantage in that high temperature growth of nanostructures may contaminate the dielectric sidewalls; by growing the nanostructures before depositing and etching the Sio₂ layer, the sidewalls of the dielectric in the via remain uncontaminated.

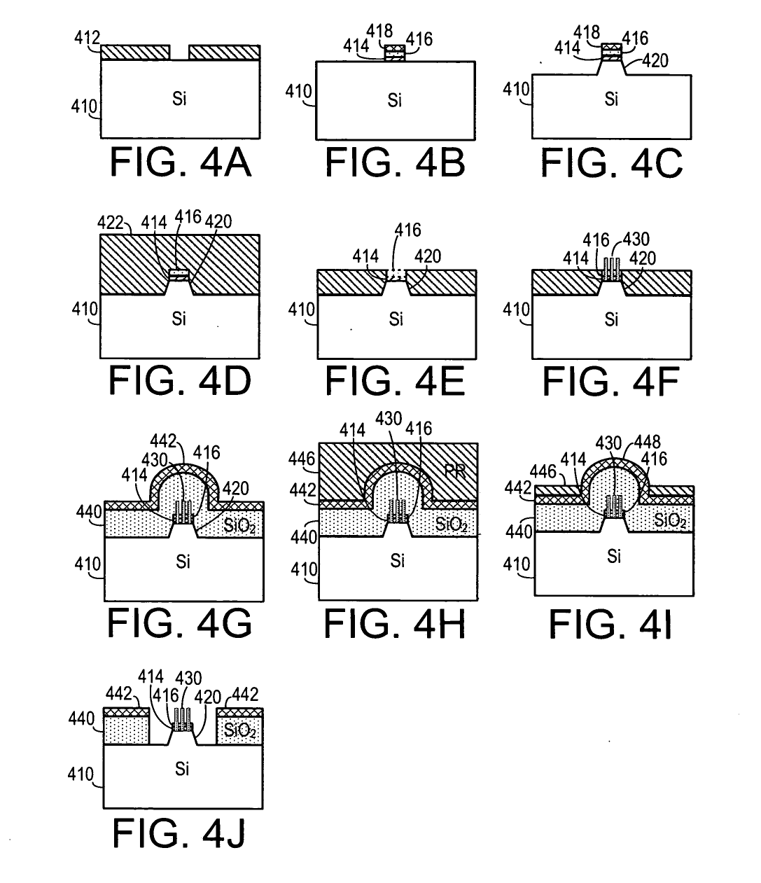

Another method of making a field emitter is shown in FIGS. 4A-4J. In this method, as shown in FIG. 4A, a layer of a mask material 412 is patterned on the substrate 410. A shown in FIG. 4B, a catalyst film 414, a template film 416, such as aluminum, and a layer of a masking metal layer 418, such as nickel, is deposited by a liftoff process on the substrate 410. The aluminum template film 416 can be converted into anodized aluminum oxide (AAO) by an anodization process, which typically defines a plurality of vertical channels. Another method of placing the catalyst particles is to deposit the catalyst film 414 into the channels by electrochemical deposition, or e-beam evaporation, or sputtering. The deposited films comprising catalyst 414, template film 414, and masking layer 418, as shown in FIG. 4B, is then etched to form a post 420, as shown in FIG. 4C. As shown in FIG. 4D, a photoresist layer 422 is placed on the structure and then heat-flowed down to achieve a flat surface, followed by an O₂ plasma etch to expose the deposited films. The masking film, such as nickel, is removed by wet etch, or dry etch, or their combination, and the aluminum film is anodized into porous AAO template 416, as shown in FIG. 4E. As shown in FIG. 4F, from the catalyst 414 exposed in the vertical holes of the AAO template layer 416 are grown one or more nanostructures 430. Use of the template layer 416 allows for precise control over the number and distribution of the nanostructures 430.

As shown in FIG. 4G, a dielectric layer 440 is then applied to the substrate 410, the post 420 and the nanostructures 430 and a conductive gate material layer 442 is applied to the dielectric layer 440. As shown in FIG. 4H, a masking material 446, such as photoresist, is placed on the gate material layer 442 and, as shown in FIG. 41, is reduced to expose the dome-shaped structure 448 of the gate material layer 442 and the dielectric layer 440. The exposed dome-shaped structure 448 is then etched away and any remaining mask material is removed, resulting in the field emitter shown in FIG. 4J. Any remaining AAO may also be removed by etching. The dome removal step can also be done by mechanical polishing, or chemical mechanical polishing (CMP). This method has the advantage of allowing for precise control of the number and spacing of the nanostructures 430 by controlling the width and porosity of the AAO template.

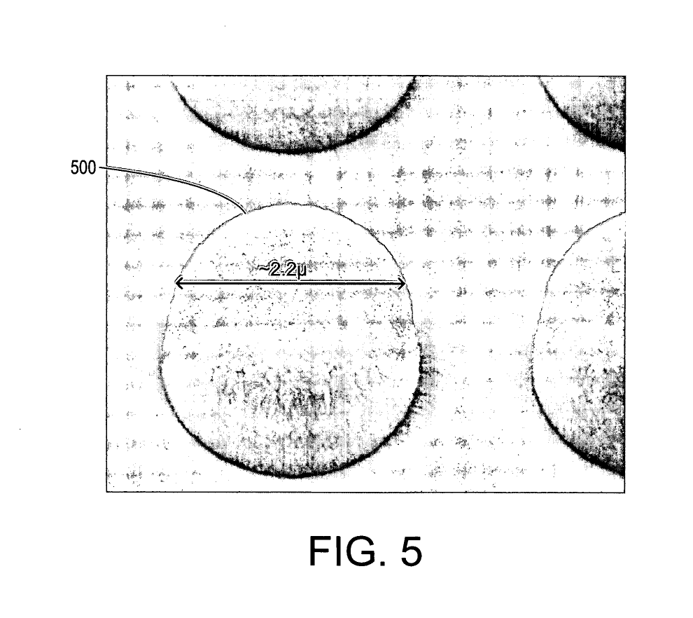

A micrograph of a dome-shaped structure 500, as discussed above, is shown in FIG. 5.

In one embodiment, the nanostructure may be formed from the substrate. This may be accomplished, for example, by selective etching of the substrate. This embodiment would have the advantages of simplicity of fabrication and lack of an interface between the nanostructure and the substrate.

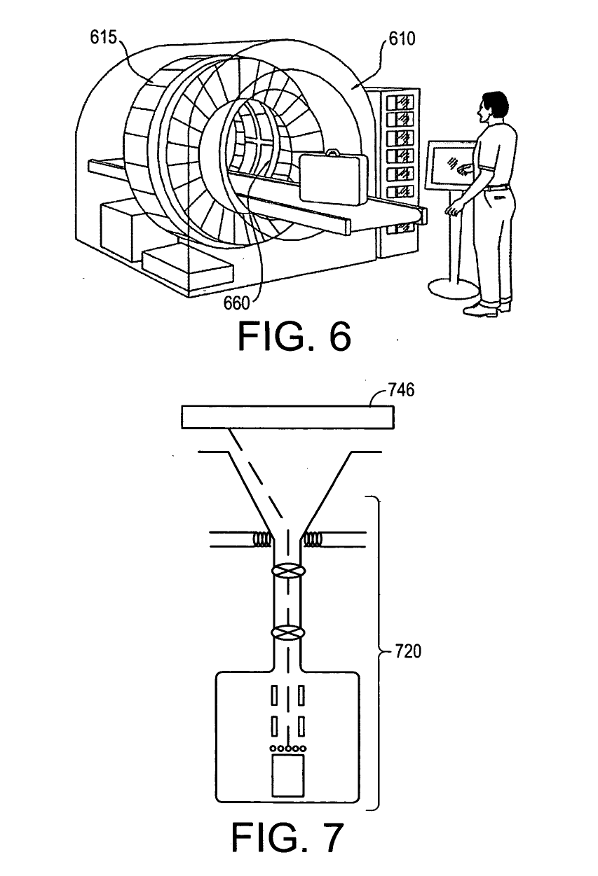

Field emitters as described herein may be useful in a number of applications requiring high reliability and high current density, including, for example, x-ray systems, high resolution displays, and high power amplifiers. In accordance with one embodiment of the present invention, depicted in FIG. 6, an x-ray system 610 generally includes an x-ray generation subsystem 615 for generating the x-ray radiation used to obtain an image of a subject, and a detector 660 for detecting the x-rays used to illuminate the subject. As shown in FIG. 7, a portion of the x-ray generation subsystem 615 may include an electron emission subsystem 720 for generating the electrons that generate x-rays when impinged upon a target 746. The electron emission subsystem 720 includes an electron source 726, which comprises the field emitter of the present invention. Each electron beam generated within the electron emission subsystem 720 may be steerable and may produce either discrete or swept focal spots on the target 746. It should be appreciated, however, that a different architecture may be utilized to effect the emission of electron beams to more than one focal spot on the target 746. For example, instead of utilizing a steerable electron emission subsystem 720 as described with reference to the x-ray generation subsystem 615, a dedicated emitter design architecture may be used. Such an x-ray generation subsystem may include an electron emission subsystem having an array of emitters, each utilizing a plurality of electron sources 726.

The electron emission subsystem 720 and the target 746 may be stationary relative to the detector 660, which may be stationary or rotating, or the electron emission subsystem 720 and the target 746 may rotate relative to the detector 660, which may be stationary or rotating. Multiple electron emission subsystems 720 may be arranged around the target 746. The x-ray system 610 may be configured to accommodate a high throughput of subjects, for example, screening of upwards of one thousand individual pieces of luggage within a one hour time period, with a high detection rate and a tolerable number of false positives. Conversely, the x-ray system 610 may be configured to accommodate the scanning of organic subjects, such as humans, for medical diagnostic purposes. Alternatively, the x-ray system 610 may be configured to perform industrial non-destructive testing.

The above described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. A method of making a field emitter, comprising the steps of:
a. forming at least one post on a semiconducting substrate, the post extending upwardly from the substrate, the post being monocrystalline with the substrate;
b. depositing a dielectric layer on the substrate, in which the dielectric layer defines a via therethrough about the post;
c. applying a conductive gate layer to the dielectric layer, so that the conductive gate layer defines an opening that is juxtaposed with the via; and
d. growing at least one nanostructure upwardly from the top surface of the post.

2. The method of claim 1, wherein the forming step comprises the steps of:
a. applying a mask to a selected region of the substrate; and
b. etching the substrate about the mask, thereby removing a portion of the substrate and leaving the post beneath the mask.

3. The method of claim 2, wherein the step of growing at least one nanostructure includes:
a. applying a nanostructure growth catalyst to the selected region of the post; and
b. growing the nanostructure from the catalyst using a vapor liquid solid process, a chemical vapor deposition process, or an evaporation process.

4. The method of claim 2, wherein the step of depositing a dielectric layer on the substrate comprises the step of depositing the dielectric layer so as to cover the nanostructure, thereby forming a dome above the post and the nanostructure and wherein the step of applying a conductive gate layer comprises depositing a conductive material onto the dielectric layer.

5. The method of claim 4, further comprising the steps of:
a. depositing a thin dielectric layer onto the conductive gate layer;
b. depositing a masking material onto the thin dielectric layer so that a portion of the thin dielectric layer attached to the dome is exposed; and
c. etching the portion of the thin dielectric layer and a portion of the conductive gate layer beneath the portion of the thin dielectric layer and a portion of the dielectric layer beneath the portion of the conductive gate layer to expose the nanostructure, the post and a portion of the substrate.

6. The method of claim 1, wherein the step of forming at least one post is performed by executing the following steps:
a. depositing a thin nanostructure growth catalyst layer onto the substrate;
b. depositing dielectric material onto the nanostructure growth catalyst layer;
c. applying a mask to a selected region of the dielectric material; and
d. etching the dielectric material and the substrate about the mask, thereby removing a portion of the dielectric material and the substrate and leaving the post beneath the mask.

7. The method of claim 6, wherein the dielectric post is reduced to less than 0.5 μm by wet etched using optical lithography.

8. The method of claim 6, further comprising the step of depositing the dielectric layer onto the substrate and the post, thereby forming a dielectric dome above the post, wherein the step of applying a conductive gate layer comprises depositing a conductive material onto the dielectric layer.

9. The method of claim 8, further comprising the steps of:
a. depositing a thin dielectric layer onto the conductive gate layer;
b. depositing a masking material onto the thin dielectric layer so that a portion of the thin dielectric layer attached to the dome is exposed; and
c. etching the portion of the thin dielectric layer and a portion of the conductive gate layer beneath the portion of the thin dielectric layer and a portion of the dielectric layer beneath the portion of the conductive gate layer to expose the post and a portion of the substrate.

10. The method of claim 1, wherein the step of depositing a dielectric layer on the substrate comprises the step of subjecting the substrate to a chemical vapor deposition environment in which the dielectric material is carried in a chemical vapor.

11. The method of claim 1, wherein the semiconducting substrate comprises a material selected from a group of materials consisting essentially of: silicon, silicon carbide, gallium nitride, or other III-V semiconductors, and combinations thereof.

12. The method of claim 1, wherein the dielectric layer comprises consisting essentially of: silicon dioxide, silicon nitride, aluminum oxide, and combinations thereof.

13. The method of claim 1, wherein the conductive gate layer comprises a material selected from a group of materials consisting essentially of: a metal, polycrystalline silicon, and combinations thereof.

14. A field emitter, comprising:
a. a semiconductor substrate having a top surface, a post extending upwardly from the top surface, the substrate and the post being monocrystalline;
b. a dielectric layer, disposed on the top surface of the substrate, the dielectric layer having an outer surface and defining a via therethrough that exposes the post;
c. a conductive gate layer disposed on the outer surface, the gate layer defining an opening that exposes the via through the dielectric layer; and
d. at least one nanostructure extending upwardly from the post.

15. The field emitter of claim 14, wherein the conductive gate layer comprises a material selected from a group of materials consisting essentially of: a metal, polycrystalline silicon, and combinations thereof.

16. The field emitter of claim 14, wherein the dielectric layer comprises a material selected from a group of materials consisting essentially of: silicon dioxide, silicon nitride, aluminum oxide, and combinations thereof.

17. The field emitter of claim 14, wherein the semiconductor substrate comprises a material selected from a group of materials consisting essentially of: silicon, silicon carbide, gallium nitride, or other III-V semiconductors and combinations thereof.

18. The field emitter of claim 14, wherein the nanostructure comprises a carbon nanotube.

19. The field emitter of claim 14, wherein the nanostructure comprises a inorganic nanorod.

20. The field emitter of claim 19, wherein the inorganic nanorod includes a material selected from a list consisting essentially of: molybdenum carbide, silicon carbide, zinc oxide and silicon.

21. The field emitter of claim 14, wherein the nanostructure comprises a nanostructure that is formed from the substrate.

22. The field emitter of claim 14, the field emitter is a component of an x-ray imaging system.
